(19) United States
(12) Patent Application Publication
(10) Pub. No.: US 2011/0298693 A1
(43) Pub. Date: Dec. 8, 2011

(54) DISPLAY APPARATUS AND DISPLAY METHOD

(75) Inventors: Tsuyoshi Tasaki, Tokyo (JP); Akihisa Moriya, Kanagawa-ken (JP); Takashi Sasaki, Kanagawa-ken (JP); Akira Kinno, Kanagawa-ken (JP); Haruhiko Okumura, Kanagawa-ken (JP); Shigeru Shimakawa, Kanagawa-ken (JP)

(73) Assignee: KABUSHIKI KAISHA TOSHIBA, Tokyo (JP)

(21) Appl. No.: 13/041,582

(22) Filed: Mar. 7, 2011

(30) Foreign Application Priority Data
Jun. 3, 2010 (JP) P2010-127753

(51) Int. Cl. G09G 5/00

(52) U.S. Cl. 345/7

(57) ABSTRACT

According to one embodiment, a display apparatus includes a generation unit and a presentation unit. The generation unit is configured to generate a CG image in a CG space having a coordinate system corresponding to a scene viewed from a view point of an observer. The CG image represents a target to be perceived by the observer. The presentation unit is configured to present the CG image to at least one eye of the observer. The generation unit generates a plurality of CG images of the target advancing to a specific coordinate in the CG space and going back from the specific coordinate based on a velocity of the vehicle. The target is perceived by the observer so that the target is advancing from of the vehicle to a specific location corresponding to the specific coordinate in the scene and stops at the specific location for a specific time.

### CROSS-REFERENCE TO RELATED APPLICATION

This application is based upon and claims the benefit of priority from Japanese Patent Application No. 2010-127753, filed on Jun. 3, 2010; the entire contents of which are incorporated herein by reference.

### FIELD

Embodiments described herein relate generally to a display apparatus and a display method.

### BACKGROUND

As a display apparatus mounted on a vehicle, a head-up display (HUD) is widely used. The HUD presents a CG image to eye (one eye or both eyes) of an observer (driver). In this case, the CG image is a target representing an advance direction (moving direction) of the vehicle, or a location to indicate to the observer.

For example, above-mentioned technique is disclosed in JP-A 2009-244355. As to this display apparatus, the CG image had better be a target for the observer to easily view. Briefly, the display apparatus for displaying such CG image is desired.

### BRIEF DESCRIPTION OF THE DRAWINGS

FIG. 1 is a block diagram of a display apparatus 1 according to a first embodiment.

FIG. 2 is a flow chart of processing of the display apparatus 1.

FIG. 3 is a detail flow chart of S204 in FIG. 2.

FIGS. 4A and 4B are schematic diagrams to explain locations represented by a target 10.

FIG. 5 is a schematic diagram of usage example of the display apparatus 1.

FIGS. 6A, 6B and 6C are schematic diagrams of other usage examples of the display apparatus 1.

FIG. 7 is a schematic diagram of a usage example of a display apparatus according to a second embodiment.

FIG. 8 is a detail flow chart of S804 of the display apparatus according to the second embodiment.

### DETAILED DESCRIPTION

In general, according to one embodiment, a display apparatus mounted on a vehicle includes a generation unit and a presentation unit. The generation unit is configured to generate a CG image in a CG space having a coordinate system corresponding to a scene viewed from a view point of an observer. The CG image represents a target to be perceived by the observer. The presentation unit is configured to present the CG image to at least one eye of the observer. The generation unit generates a plurality of CG images of the target advancing to a specific coordinate in the CG space and going back from the specific coordinate based on a velocity of the vehicle. The target is perceived by the observer so that the target is advancing from the vehicle to a specific location corresponding to the specific coordinate in the scene and stops at the specific location for a specific time.

Hereinafter, embodiments of the present invention will be explained by referring to the drawings. The present invention is not limited to the following embodiments.

### The First Embodiment

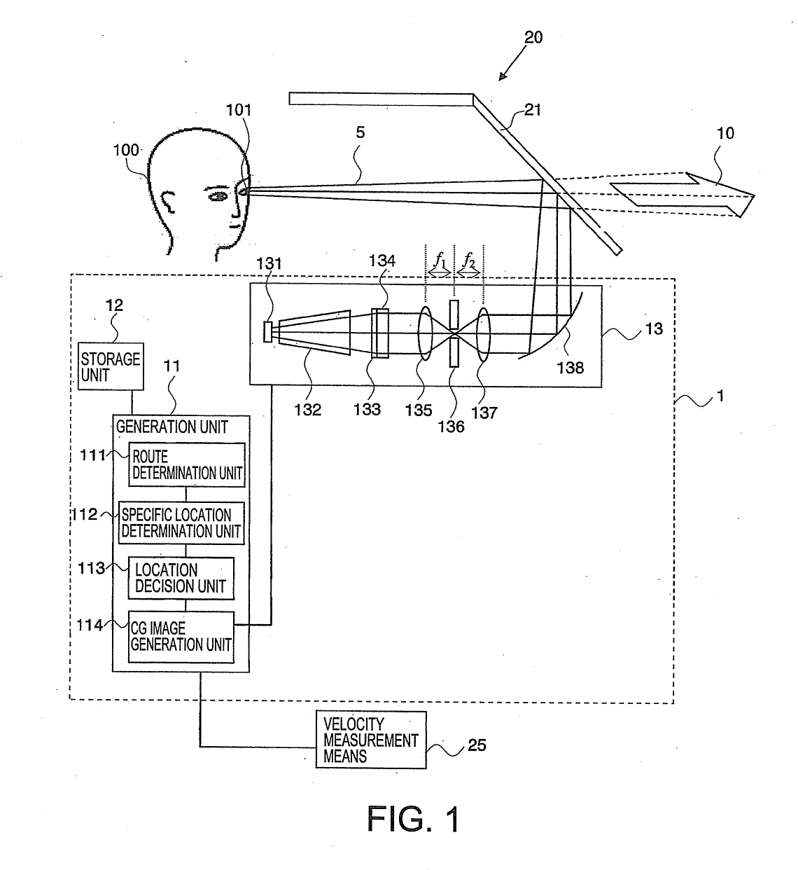

In FIG. 1, a display apparatus 1 is a head-up display mounted on a vehicle 20, which is used with a navigation system thereof. The display apparatus 1 presents a light flux 5 (including a CG image of a target 10) to eye 101 (one eye or both eyes) of an observer (driver) 100. The target 10 is an arrow representing an advance direction of the vehicle 20 or a location to indicate to the observer 100. By using this apparatus 1, the observer 100 perceives the CG image of the target 10 as an image overlapped with a scene in front of a windshield 21.

At a timing when the vehicle 20 approaches a temporary destination along a route to a final destination, the display apparatus 1 starts to display the CG image of the target 10. The temporary destination is a place to guide or urge the observer 100 to pay attention along the route to the final destination, for example, an intersection to turn to the right or left.

The display apparatus 1 makes the observer 100 perceive, in a front scene viewed by the observer 100, that the target 10 is moving toward the temporary destination and, after reaching the temporary destination, the target 10 stops at the temporary destination for a specific time. As a result, the display apparatus 1 can present the CG image of the target for the observer to easily view.

The display apparatus 1 includes a generation unit 11, a storage unit 12, and a presentation unit 13. The generation unit 11 includes a route determination unit 111, a specific location determination unit 112, a location decision unit 113, and a CG image generation unit 114. The generation unit 11 and the storage unit 12 may be realized as a CPU (Central Processing Unit) and a memory used by the CPU.

When the route determination unit 111 receives information of the final destination (desired by the observer 100) of the vehicle 20, the route determination unit 111 determines a route for the vehicle 20 to trace before arriving at the final destination. Map information includes a route map. For example, the map information is stored in the storage unit 12.

The specific location determination unit 112 determines one or a plurality of temporary destinations along the route (determined by the route determination unit 111). The temporal destinations are stored in the storage unit 12.

The location decision unit 113 decides whether the vehicle 20 is near any of temporary destinations by using vehicle information. The vehicle information includes the present location and a velocity of the vehicle 20. The vehicle information is acquired from a location measurement means (not shown in FIG. 1, for example, GPS) to measure the present location of the vehicle and a velocity measurement means 25 (For example, a speed meter) to measure a velocity of the vehicle 20.

When the vehicle 20 is near the temporary destination, the CG image generation unit 114 generates a plurality of CG images of the target 10. Each CG image is generated in order for the observer 100 to perceive the target 10 moving from a start position (a location initially indicated by the target on the route) to the temporary destination and stopping at the temporary destination for a specific time. The CG image generation unit 114 outputs each CG image of the target 10 to the presentation unit 13. Its detail processing is explained afterwards.

The presentation unit 13 presents a light flux 5 (including CG image of the target 10) to the observer 100. Briefly, the presentation unit 13 irradiates the light flux 5 toward a front glass 21. A combiner may be installed onto the front glass 21. The front glass 21 reflects the light flux 5 toward eyes 101 of the observer 100.

The presentation unit 13 includes a light source 131, a limiter unit 132, a diffusion unit 133, an image forming unit 134, a first lens 135, an aperture unit 136, a second lens 137, and a reflection plate 138.

Assume that a focal distance of the first lens 135 and the second lens 136 is f1 and f2 respectively. The aperture unit 136 is installed at a position having a distance f1 from the first lens 135 and a distance f2 from the second lens 137.

As to the light flux 5 irradiated from the light source 131, the advance direction is limited by the limiter unit 132. Under this condition, the light flux 131 is incident onto the image forming unit 134 having the diffusion unit 133. By the diffusion unit 133, the light flux 5 is diffused and uniformly incident onto the image forming unit 134. By partially transmitting or shutting the light flux 5, the image forming unit 134 forms a light flux 5 having shape of the target 10.

The light flux 5 from the image forming unit 134 is passed through the first lens 135, the aperture unit 136 and the second lens 137. The light flux 5 of which divergence angle (angle spread by the light flux 5) is controlled is incident onto the reflection plate 138. The reflection plate 138 reflects the light flux 5 toward the front glass 21.

The image forming unit 134 is located at a side of the light source 131 from the aperture unit 136. Accordingly, in comparison with a case that the aperture unit 136 is located at a side of the light source 131 from the image forming unit 134, a transmittance of the light flux 5 passed through the image forming unit 134 rises. As a result, a power consumption of the light source 131 can be suppressed.

As the light source 131, a light emitting diode, a high pressure mercury lamp, a halogen lamp or a laser, are used. As the limiter unit 132, a taper light gas is used. As the diffusion unit 133, a diffusion filter or a diffusion plate is used. As the image forming, unit 134, a liquid crystal display or a digital mirror device is used.

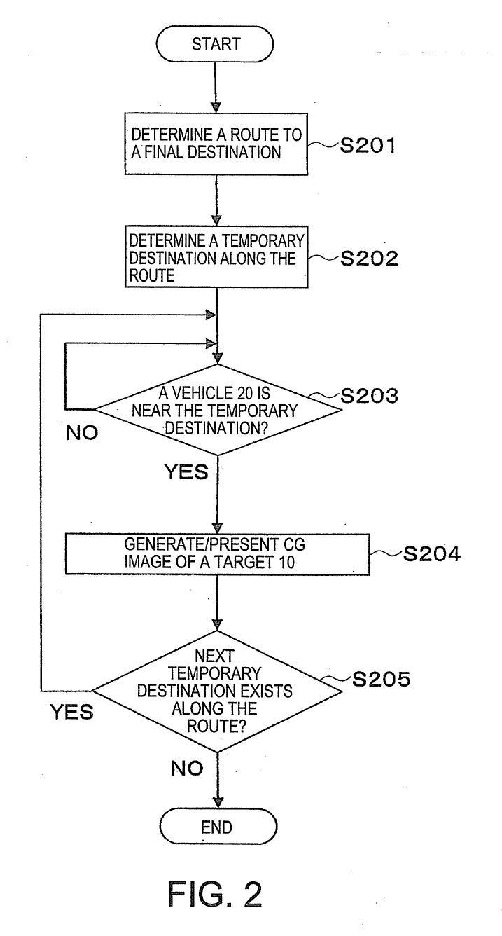

By referring to FIG. 2, processing to display a target by the display apparatus 1 is explained. The route determination unit 111 determines a route to a final destination (S201). Briefly, the route determination unit 111 reads map information from the storage unit 12. By using the location measurement means (For example, GPS), the route determination unit 111 calculates the present location of the vehicle 20. The present location may be displayed as a position P(x,y) based on some point. For example, the position P(x,y) may be represented as (longitude, latitude).

After the final destination is determined (For example, the observer 100 indicates a final destination by an input device), the route determination unit 111 determines a route to be traced by the vehicle 20. The route represents a path from the present position to the final destination.

Along the route to the final destination, the specific location determination unit 112 determines one or a plurality of temporary destinations (S202). For example, the specific location determination unit 112 determines a position Pₚ=(Xₚₙ,Yₚₙ) (n=1,2,3, . . . ) of a cross point to turn to the right or the left along the route, as the temporary destination. A location of the temporary destination is stored in the storage unit 12.

While the vehicle 20 is running, the location decision unit 113 decides whether the vehicle 20 is near the temporary destination (S203). For example, it is decided whether a distance from the present location P_{c} of the vehicle 20 to the temporary destination Pₚ is within a specific value. The present location P_{c} may be a pointed end of the vehicle 20 or a position of the observer 100 who gets in the vehicle 20.

First, by using the location measurement means, the location decision unit 113 calculates the present location P_{c}=(X_{c},Y_{c}) of the vehicle 20. Next, the location decision unit 113 calculates a distance D from the present location P_{c} to the temporary destination. Last, the location decision unit 113 decides whether the distance D is within a specific value.

For example, the location decision unit 113 decides whether the distance D is within 100 m. If the distance D is not within the specific value (NO at S203), this decision processing is repeated until the distance D is within the specific value.

If the distance D is within the specific value (YES at S203), the CG image generation unit 114 generates a CG image of the target 10 for the observer 100 to perceive the target 10 advancing (moving forward) from the start position P₀ to the temporary destination Pₚ and stopping at the temporary destination Pp (S204). The start position P₀ is a location initially indicated by the target 10.

The start position may be preset, when the distance D is within the specific value, as a position P₀=(x₀,y₀) moved a specific distance from the present location Pc₀ of the vehicle 20 to the temporary destination Pₚ. For example, when a distance to the temporary destination Pₚ is within 100 m, a position moved 20 m from the present location Pc₀ of the vehicle 20 to the temporary destination Pₚ may be set as the start position P₀. Generation of the CG image is executed until the vehicle 20 arrives at the temporary destination Pₚ from the start position P₀.

When the vehicle 20 arrives at the temporary destination Pₚ, the location decision unit 113 decides whether a next temporary destination exists along the route to the final destination (S205). If the next temporary destination does not exist along the route (NO at S205), the display apparatus 1 completes the processing.

If the next temporary destination exists along the route (YES at S205), processing is forwarded to S203. In this case, above-mentioned processing is executed for the next temporary destination. Thus far, processing to display the target by the display apparatus 1 was explained.

The CG image generation unit 114 generates CG image of the target 10 in CG space defined by CG coordinate system (x′,y′) based on the vehicle 20. A view point in the CG coordinate system had better be previously matched with an actual view point of the observer 100. For example, an origin of the CG coordinate system may be matched with the actual view point of the observer 100.

By this processing, the CG image generation unit 114 makes the observer 100 perceive the target 10 overlapped with a front scene of the front glass 21. Furthermore, by using a camera or a sensor (not shown in FIG.), the CG image generation unit 114 may measure a view point of the observer 100 at a specific interval and adjust the view point in the CG coordinate system.

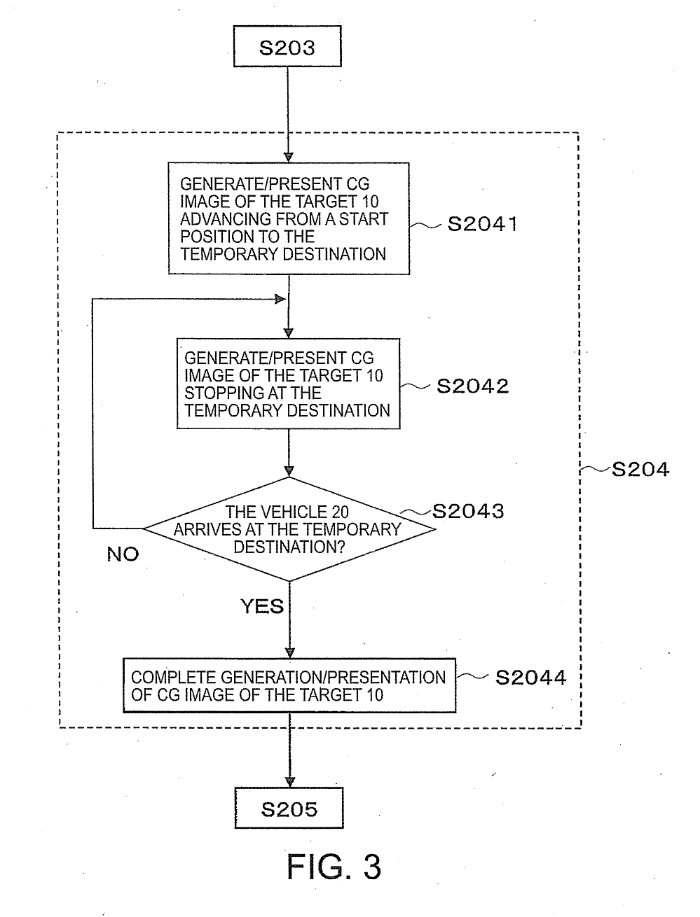

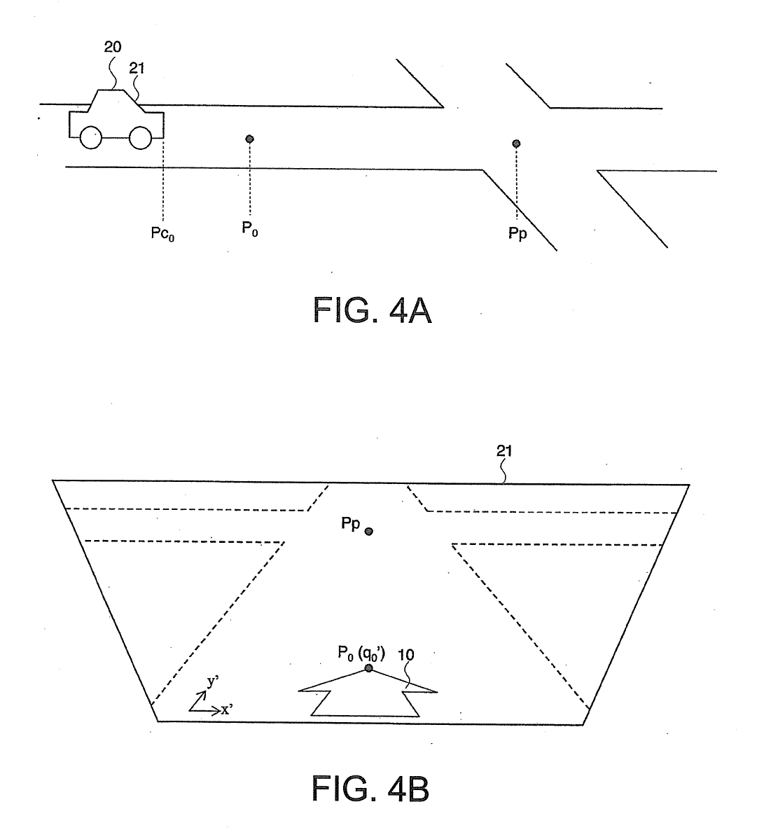

Processing to generate CG image is explained in detail. FIG. 3 is a flow chart of detail processing of S204. FIG. 4 is one example representing relationship among the target 10, the start position P₀ and the temporary destination Pₚ. FIG. 4A is an overlook plan from the outside, and FIG. 4B is a plan from the view point of the observer 100.

The CG image generation unit 114 generates a plurality of CG images in order for the observer 100 to perceive the target 10 advancing from the start position P₀ to the temporary destination Pₚ. Whenever each CG image of the target 10 is generated, the presentation unit 13 presents the CG image to the observer 100 (S2041).

From a coordinate g₀′ (corresponding to the start position Po) in the CG space, the CG image generation unit 114 starts to generate the CG image of the target 10. For example, by an equation (1), the CG image generation unit 114 may determine a coordinate g₀′=(x₀′,y₀′) of the target 10 in the CG coordinate system (x′,y′) using the present location Pc₀ (of the vehicle 20) and the start position P₀.

q₀′=P₀−Pc₀=(x₀−Xc,y₀−Yc) (1)

The CG image generation unit 114 generates CG image of the target 10 at a coordinate g₀′=(x₀′,y₀′) in the CG coordinate system. If the target 10 is an arrow, the CG image may be generated so that a pointed end of the arrow is located at the coordinate q₀′=(x₀′,y₀′).

Based on a velocity of the vehicle 20 when the presentation unit 13 presents one CG image of the target 10, the CG image generation unit 114 may determine a coordinate qₖ′=(xₖ′,y′) (k=1,2, . . . ) to display a next CG image in the CG coordinate system by an equation (2) and generate the CG image of the target 10 in order. As to the equation (2), a coordinate of the present position of the vehicle 20 is subtracted from the start position P₀, and the coordinate qₖ′ in the CG coordinate system is calculated using velocities of the vehicle 20 and the target 10.

Briefly, at an interval Δt (For example, 1/30 second), CG image of k-th target 10 to be displayed at the coordinate qₖ′ is generated in order. Δt represents a time to present one CG image by the presentation unit 13.

$${q}_{k}^{′} = {P}_{0} + {\sum }_{i = 0}^{k - 1} {v}_{i} Δ t - P {c}_{0} - {\sum }_{i = 0}^{k - 1} V {c}_{i} Δ t \qquad ( 2 )$$

In the equation (2), Vcₖ represents a velocity (vector) of the vehicle 20 when CG image of k-th target 10 is presented. The CG image generation unit acquires Vcₖ from the velocity measurement means 25. Vₖ represents a velocity (vector) of k-th target 10. By using Vₖ, a position of (k+1)-th target 10 on the route is determined. Vc₀ represents a velocity (vector) of the vehicle 20 when CG image of the target 10 at the start position P₀ is presented. V₀ represents a velocity (vector) of the target 10 at the start position P₀. Moreover, a size (|vₖ|) of vₖ maybe a constant value (For example, (|v₀|)). However, its size had better be larger than a size of velocity of the vehicle 20.

Furthermore, in order for the target 10 not to be overtaken by the vehicle 20, |vₖ| maybe changed based on the size |Vcₖ| of Vcₖ. For example, |vₖ| may be changed based on |Vcₖ| so that |vₖ| is always larger than |Vcₖ|.

In the equation (2), “k=0” represents the target 10 indicating the start position P₀. Furthermore, as shown in an equation (3), a direction of k-th target 10 had better be a direction from a unit vector of velocity Vcₖ of the vehicle 20 to a unit vector of velocity vₖ of k-th target 10.

$${d}_{k}^{′} = \frac{{v}_{k}}{\vert {v}_{k} \vert} - \frac{V {c}_{k}}{\vert V {c}_{k} \vert} \qquad ( 3 )$$

By this processing, based on the present location and the velocity of the vehicle 20, the CG image generation unit 114 can correct a direction indicated by the target 10.

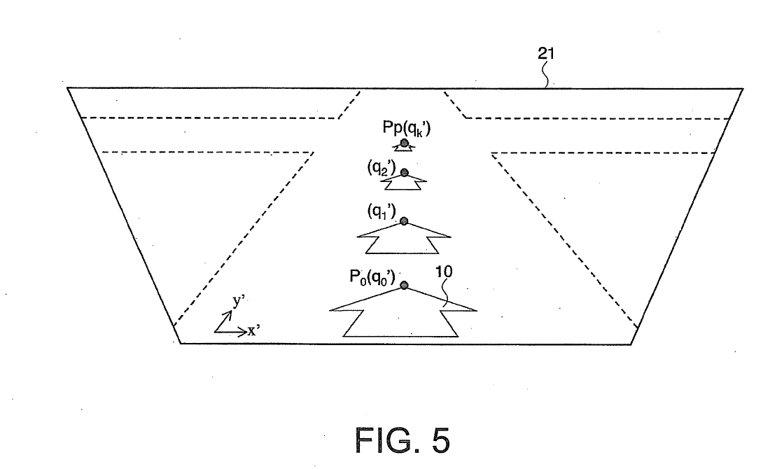

FIG. 5 is a plan from a view point of the observer 100, on which the target 10 is advancing to the temporary destination. In FIG. 5, a sign described in a parenthesis represents a coordinate qₖ′ in the CG coordinate system. As mentioned-above, the CG image generation unit 114 generates a CG image of the target 10 at a coordinate qₖ′ in the CG coordinate system so that the target 10 is advancing from the start position to the temporary destination. The presentation unit 13 dynamically presents the CG image to the observer 100. By this processing, the observer 100 perceives the target 10 advancing along the route.

After the CG image of the target 10 arriving at the temporary destination is generated, the CG image generation unit 114 generates a CG image of the target 10 for the observer 100 to perceive the target 10 stopping at the temporary destination for a specific time. The presentation unit 13 dynamically presents the CG image of the target 10 to the observer 100 (S2042).

Briefly, the CG image generation unit 114 may decide whether CG image of the target 10 arriving at the temporary destination is generated by using an equation (4). The equation (4) represents that a location (generated in order from the present location Pc₀ of the vehicle at a timing when the start position is determined) of the target 10 along the route is the temporary destination Pₚ.

$$\vert P {c}_{0} + {\sum }_{i = 0}^{k - 1} {v}_{i} Δ t - P p \vert ≺ δ \qquad ( 4 )$$

In the equation (4), δ represents a threshold which an error occurred by packaging is taken into consideration. For example, δ may be set as 0.1.

While the vehicle 20 is approaching the temporary destination Pₚ, the CG image generation unit 114 generates CG image of the target 10 so that the target 10 is approaching a view point of the observer 100 in the CG coordinate system.

Briefly, the CG image generation unit 114 generates CG image so that the target 10 is going back based on a velocity of the vehicle 20 in CG space. For example, based on a velocity of the vehicle 20 at a timing when the presentation unit 13 presents CG image of a target 10, the CG image generation unit 114 may calculate a coordinate Qₛ′=(xₛ′,yₛ′) (s=1,2, . . . ) of the target 10 in the CG coordinate system, by an equation (5).

$${Q}_{s}^{′} = P p - P {c}_{0} - {\sum }_{i = 0}^{s - 1} V {c}_{i} Δ t \qquad ( 5 )$$

In the equation (5), Vcₛ represents a velocity (vector) of the vehicle 20 at a timing when CG image of s-th target 10 is presented. Furthermore, as shown in an equation (6), a direction dₛ′ of s-th target 10 had better be a direction from a unit vector of velocity Vcₛ of the vehicle 20 to a unit vector of velocity Vₛ of s-th target 10.

$${d}_{s}^{′} = \frac{{v}_{s}}{\vert {v}_{s} \vert} - \frac{V {c}_{s}}{\vert V {c}_{s} \vert} \qquad ( 6 )$$

By this processing, the CG image generation unit 114 can correct a direction indicated by the target 10, based on a location and a velocity of the vehicle 20.

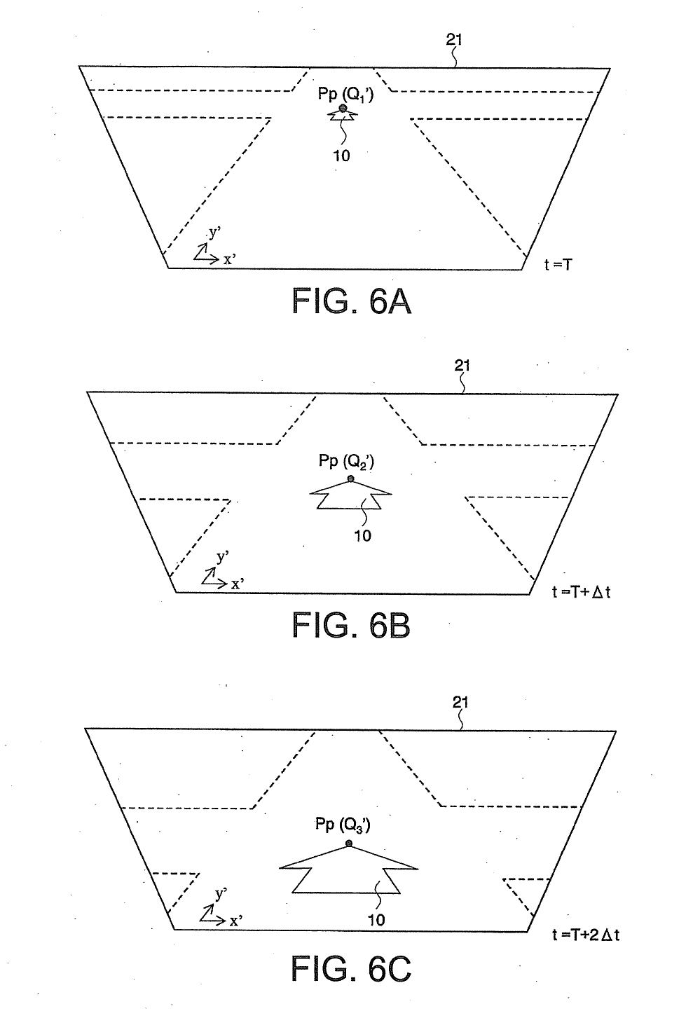

FIG. 6 is plans viewed from a view point of the observer 100, on which the target 10 stops at a temporary destination. FIG. 6A shows a scene at a timing t=T. At this riming, the target 10 has already arrived at the temporary destination Pₚ. FIG. 6B shows a scene at a timing t=T+Δt. FIG. 6C shows a scene at a timing t=T+2Δt. In FIGS. 6A-6C, a sign described in a parenthesis represents a position of a coordinate Qₛ′ in the CG coordinate system.

As shown in FIGS. 6A-6C, while the vehicle 20 is approaching the temporary destination Pₚ, the CG image generation unit 114 calculates coordinates Qₛ′, Qₛ₊₁′ and Qₛ₊₂′ of the target 10 in the CG coordinate system so that the target 10 is gradually approaching a view point of the observer 100. By this processing, the observer 100 perceives the target 10 stopping at the temporary destination.

By using the location measurement means, the CG image generation unit 114 decides whether the vehicle 20 arrives at the temporary destination Pₚ (S2043). If it is decided that the vehicle 20 does not arrive at the temporary destination (NO at S2043), processing is forwarded to S2042.

If it is decided that the vehicle arrives at the temporary destination (YES at S2042), the CG image generation unit 114 completes generation of CG image of the target 10. The presentation unit 13 completes presentation of CG image of the target 10 (S2044). As mentioned-above, detail processing of S204 is explained.

As to the display apparatus 1 of the first embodiment, CG image of the target for the observer to easily view can be presented. Moreover, in the first embodiment, the generation unit 11 executes all processing using two-dimensional coordinate (x,y) However, execution of processing is not limited to this method. For example, by executing processing using three-dimensional coordinate (x,y,z), the generation unit 11 can determine coordinates to generate the target 10, based on ups and downs of the route.

Furthermore, the CG image generation unit 114 may change a time Tm required for the target 10 to move from the start position P₀ to the temporary destination Pₚ, and a time Tₛ while the target 10 stops at the temporary destination Pₚ, based on a velocity of the vehicle 20.

Furthermore, in the first embodiment, a method for indicating a temporary destination to the observer is explained. As to a method for indicating a final destination to the observer, the same processing can be applied.

In the first embodiment, the display apparatus 1 mounted onto a vehicle (car) is explained as an example. However, examples are not limited to this one. For example, the display apparatus 1 can be used for a general vehicle such as a ship, a helicopter, or a airplane.

Furthermore, in the first embodiment, by reflecting a light flux 5 on a front glass 21 of the vehicle 20, the presentation unit 13 presents the light flux 5 to eyes 101 of the observer 100. However, presentation processing of the light flux 5 is not limited to this method. For example, the image forming unit 134 is equipped on the front glass 21. In this case, the light flux 5 from the image forming unit 134 is directly presented to eyes 101 of the observer 100.

(Modification)

In a modification of the first embodiment, the CG image generation unit 114 generates CG image of the target 10 at a fixed velocity u (vector). This modification is applied to a case that the vehicle 20 is running at a fixed velocity Uc. In this case, the CG image generation unit 114 need not determine coordinates of the target 10 in CG space by the equation (2). Accordingly, processing cost can be suppressed. Hereinafter, the modification is explained in detail.

If it is decided that the vehicle 20 is near the temporary destination Pₚ (YES at S203), the CG image generation unit 114 generates CG image in CG space by advancing the target 10 at a fixed velocity in order.

In this case, based on a velocity u (fixed value) of the target 10, a distance D between the present location Pc₀ of the vehicle 20 and the temporary destination Pₚ, a velocity tic (fixed value) of the vehicle 20 and a presentation time Δt of one image, the CG image generation unit 114 generates CG image for the observer 100 to perceive the target 10 advancing to the temporary destination Pₚ.

For example, assume that “u=80 (m/s) D=100 (m), Uc=60 (m/s) and Δt= 1/30 (s) ” By generating CG images of 150 slices in order, the CG image generation unit 114 makes the observer 100 perceive the target 10 advancing to the temporary destination Pₚ.

After that, in order for the observer 100 to perceive the target 10 stopping at the temporary destination Pₚ, the CG image generation unit 114 executes the same processing as the first embodiment.

As to the modification, processing cost of the CG image generation unit 114 can be suppressed.

### The Second Embodiment

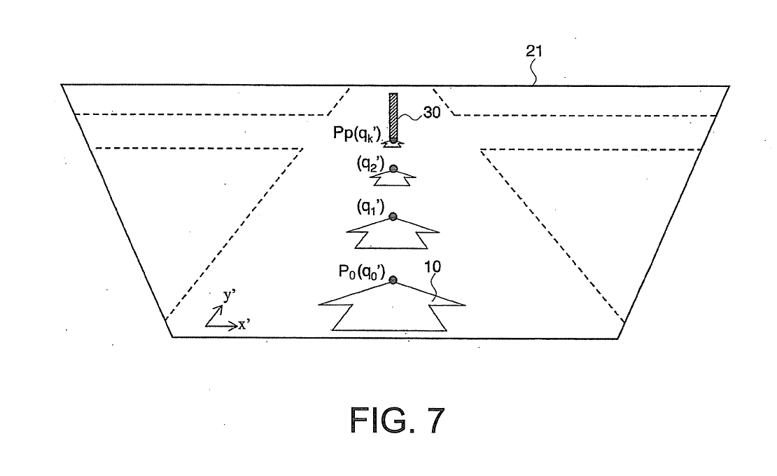

As to the second embodiment, processing of the CG image generation unit 114 is different from that of the first embodiment. FIG. 7 shows a scene displayed by a display apparatus of the second embodiment. In the second embodiment, while CG images of a target 10 advancing from a start location P₀ to a temporary destination Pₚ are generated, the CG image generation unit 114 generates CG image of another target 30 stopping at the temporary destination Pₚ. For example, a shape of another target 30 is a stick vertically standing at the temporary destination Pₚ. By this processing, the observer 100 can intuitively recognize the temporary destination Pₚ.

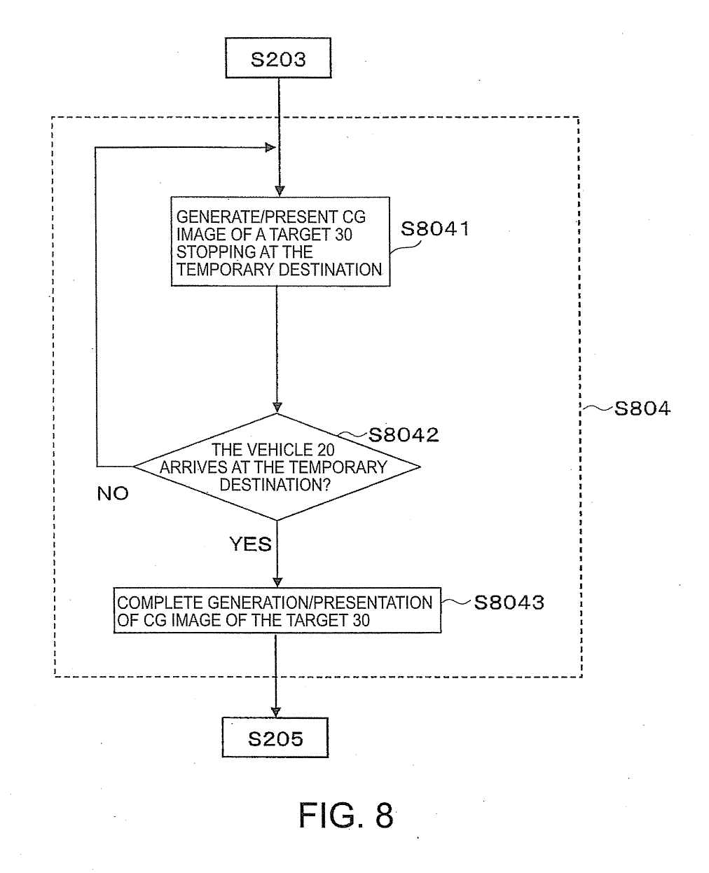

FIG. 8 is a flow chart of generation/presentation processing of CG image of a target 30. In the second embodiment, by replacing S204 in FIG. 3 of the first embodiment with S804 in FIG. 8, CG image of the target 30 is generated and presented. Processing of S204 and processing of S804 are executed in parallel. Hereinafter, processing of S804 is explained in detail.

If it is decided that the vehicle 20 is near the temporary destination Pₚ (YES at S203), the CG image generation unit 114 generates CG image for the observer 100 to perceive the target 30 stopping at the temporary destination Pₚ. The presentation unit 13 presents the CG image (S8041).

For example, by the equation (5), the CG image generation unit 114 determines a coordinate Qₛ′ of a target 10 in CG coordinate system, and locates another target 30 at the coordinate Qₛ′.

By using the location measurement means, the CG image generation unit 114 decides whether the vehicle 20 arrives at the temporary destination Pₚ (S8042). If it is decided that the vehicle 20 does not arrive at the temporary destination Pₚ (NO at S8042), processing is forwarded to S8041.

If it is decided that the vehicle 20 arrives at the temporary destination P, (YES at S8042), the CG image generation unit 114 completes generation of CG image of the target 30. The presentation unit 13 completes presentation of CG image of the target 30 (S8043).

The CG image generation unit 114 executes processing of FIG. 8 and processing of FIG. 3 in parallel. Briefly, while CG images of the target 10 advancing from the start position P₀ to the temporary destination Pₚ are generated, the CG image generation unit 114 generates CG image of another target 30 stopping at the temporary target Pₚ.

Moreover, if the target 30 has a bar shape, the CG image generation unit 114 may generate the target 30 of which lower part than a specific height is semi-transparent. By this processing, even if the vehicle 20 is vibrated by ups and downs of a surface where the vehicle 20 is running, the observer 100 can correctly recognize the temporary destination Pₚ.

As mentioned-above, in the second embodiment, the display apparatus to present CG image of the target for the observer to easily view can be provided.

While certain embodiments have been described, these embodiments have been presented by way of examples only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display apparatus mounted on a vehicle, comprising:
a generation unit configured to generate a CG image in a CG space having a coordinate system corresponding to a scene viewed from a view point of an observer, the CG image representing a target to be perceived by the observer; and
a presentation unit configured to present the CG image to at least one eye of the observer;
wherein the generation unit generates a plurality of CG images of the target advancing to a specific coordinate in the CG space and going back from the specific coordinate based on a velocity of the vehicle, and
wherein the target is perceived by the observer so that the target is advancing from the vehicle to a specific location corresponding to the specific coordinate in the scene and stops at the specific location for a specific time.

2. The apparatus according to claim 1,
wherein the generation unit comprises
a route determination unit configured to determine a route to a final destination of the vehicle by using map information;
a specific location determination unit configured to determine the specific location along the route;
a location decision unit configured to decide whether a distance between the vehicle and the specific location is equal to or smaller than a specific threshold; and
a CG image generation unit configured to generate the plurality of CG images when the distance is equal to or smaller than the specific threshold.

3. The apparatus according to claim 2,
wherein the CG image generation unit calculates a position coordinate to locate the target in the CG space based on the velocity of the vehicle, and generates the CG image of the target located at the position coordinate in order.

4. The apparatus according to claim 3,
wherein the CG image generation unit generates CG images of the target going back from the specific coordinate based on the velocity of the vehicle, when starting to generate the CG image of the target located at the position coordinate.

5. A display method of a display apparatus mounted on a vehicle, comprising:
generating a CG image in a CG space having a coordinate system corresponding to a scene viewed from a view point of an observer, the CG image representing a target to be perceived by the observer; and
presenting the CG image to at least one eye of the observer;
wherein the generating comprises generating a plurality of CG images of the target advancing to a specific coordinate in the CG space and going back from the specific coordinate based on a velocity of the vehicle, and
wherein the target is perceived by the observer so that the target is advancing from the vehicle to a specific location corresponding to the specific coordinate in the scene and stops at the specific location for a specific time.
